(19) United States
(12) Patent Application Publication
(10) Pub. No.: US 2016/0034065 A1
(43) Pub. Date: Feb. 4, 2016

(54) CONTROLLING FORMS OF INPUT OF A COMPUTING DEVICE

(71) Applicant: Hewlett-Packard Development Company, L.P., Fort Collins, CO (US)

(72) Inventors: Zhen Yin, Houston, TX (US); Monji G. Jabori, Houston, TX (US); Richard E. Hodges, Magnolia, TX (US)

(21) Appl. No.: 14/448,239

(22) Filed: Jul. 31, 2014

(51) Int. Cl. G06F 3/044; G06F 3/0354

(52) U.S. Cl. CPC G06F 3/044; G06F 3/03545; G06F 2203/04106

(57) ABSTRACT

Examples disclosed herein control computing device input. One example includes activating a touchscreen of a computing device and enabling a capacitive touch control of the computing device for user selection as a device input to initiate a device action. The example further includes disabling the capacitive touch control based on a pen event with the touchscreen, wherein the pen event is triggered when a digital pen is to be placed within a predefined distance from the touchscreen.

### BACKGROUND

The emergence and popularity of mobile computing has made portable computing devices, due to their compact design and light weight, a staple in today's marketplace. Tablet computers and all-in-one devices are examples of portable computing devices that are widely used. Tablet computers and all-in-one devices generally employ a touchscreen on a display surface of the device that may be used for both viewing and input. Users of such devices may interact directly with what is displayed by touching the screen with simple or multi-touch gestures. Such gestures may be performed, for example, via fingers or a digital pen.

### BRIEF DESCRIPTION OF THE DRAWINGS

FIG. 1 is a block diagram illustrating a computing device, according to an example;

FIG. 2 illustrates the computing device and a digital pen associated with the computing device, according to an example; and

FIG. 3 is a flow diagram in accordance with an example of the present disclosure.

### DETAILED DESCRIPTION

In addition to the touchscreen, the display surface of such computing devices may include buttons, for example, as a device input to initiate a device action. As an example, a device may include a home button for returning to the home screen, or a back button for returning to the previous screen illustrated on the device. Examples of buttons disposed on the display surface include, but are not limited to, physical buttons, that get physically depressed when pressed, and buttons with a capacitive touch control, that are capacitively activated due to user touch.

By having multiple forms of input on the display surface of the device (e.g., the touchscreen and the buttons), it is critical that the operation of one form of input does not interfere with the operation of another form of input. For example, while a user interacts with the touchscreen, either using a finger or a digital pen, the user may accidentally touch another form of input, such as the home button (e.g., by the palm or wrist). As a result, the home button controller may mistake unintentional touch as an attempt to return to the home screen. This false trigger on the home button may affect the seamlessness of the user's work.

Examples disclosed herein provide the ability for disabling or ignoring input from one form of input on the display surface of a computing device while input is being received from another form of input on the display surface. For example, while a digital pen is interacting with the touchscreen of a tablet computer, the buttons disposed on the display surface of the tablet may be disabled, or input from the buttons may be ignored. By disabling or ignoring input from one form of input while input is being received from another form of input, false triggers due to unintentional touch may be avoided.

In one example, a method generally includes activating a touchscreen of a computing device and enabling a capacitive touch control of the computing device for user selection as a device input to initiate a device action. The method includes disabling the capacitive touch control based on a pen event with the touchscreen, wherein the pen event is triggered when a digital pen is to be placed within a predefined distance from the touchscreen.

In another example, a computing device generally includes a touchscreen and a first controller to activate the touchscreen. The computing device includes a capacitive touch control for user selection as a device input to initiate a device action and a second controller electrically connected to the first controller. The second controller is to enable the capacitive touch control for the user selection, and ignore the device input from the capacitive touch control based on a pen event with the touchscreen. The pen event is triggered when a digital pen is to be placed within a predefined distance from the touchscreen.

In yet another example, a computing device, generally includes a non-transitory computer-readable storage medium and a plurality of programming instructions stored in the storage medium. In response to execution of the programming instructions by a processing resource, the computing device is to activate a first form of input of the computing device and enable a second form of input of the computing device for user selection as a device input to initiate a device action. The computing device is to disable the second form of input based on a pen event with the first form of input, wherein the pen event is triggered when a digital pen is to be placed within a predefined distance from the first form of input.

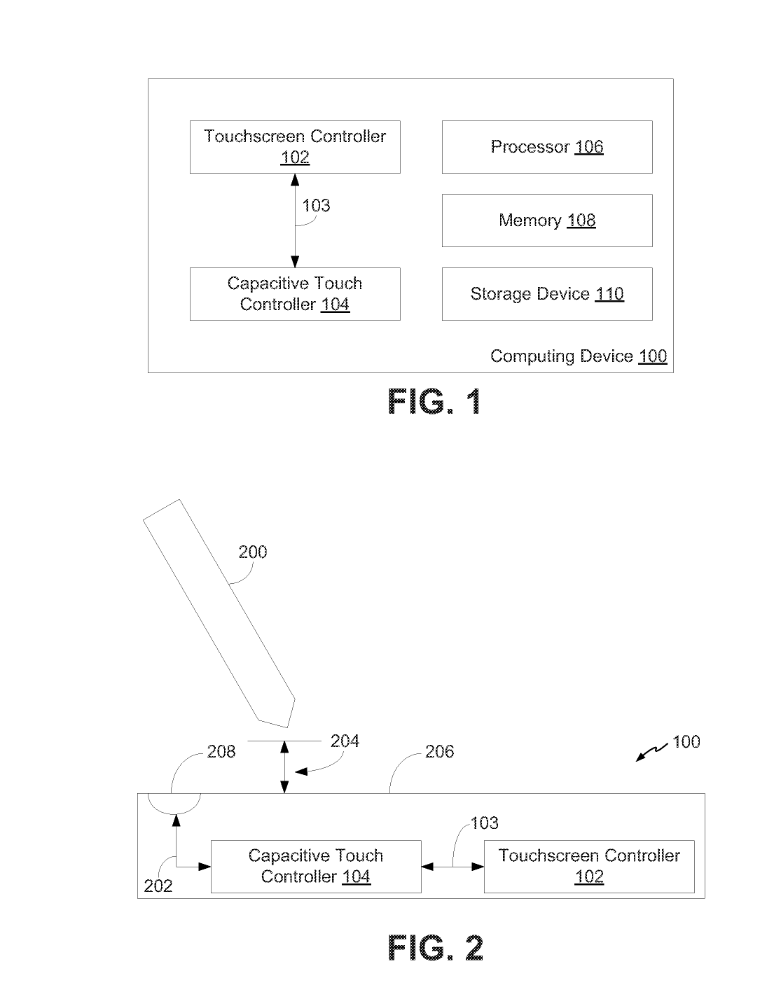

With reference to the figures, FIG. 1 is a block diagram illustrating a computing device 100, with a touchscreen controller 102 for controlling the touchscreen of the device 100, and a capacitive touch controller 104 for controlling capacitive touch control buttons disposed on the display surface of the device 100, according to an example. Other types of buttons for initiating a device action may be disposed on the display surface of the device 100, and may not be limited to capacitive touch control buttons. As a result, a touch controller in place of the capacitive touch controller 104 may be included in the device 100. As will be further described, the controllers 102, 104 may be electrically connected to each other and communicate via 103. As an example, the controllers 102, 104 may each have general purpose input-outputs (GPIOs) and/or enable/disable signals. The signals from both controllers 102, 104 may be connected together (e.g., indicated by 103) so that the two controllers 102, 104 can communicate. For example, the controllers 102, 104 may communicate with each other and disable or ignore input from one form of input (e.g., the capacitive touch control buttons) while input is being received from another form of input (e.g., the touchscreen), avoiding false triggers.

The computing device 100 may be, for example, a tablet computer, all-in-one device, laptop computer, desktop computer, mobile device, cellular phone, wearable computing device, retail point of sale device, workstation, thin client, gaming device, among others. The computing device 100 also includes a processor 106 and a storage device 110. The components of the computing device 100 may be connected and communicate through a system bus (e.g., PCI, ISA, PCI-Express, HyperTransport®, NuBus, etc.). The processor 106 can be a single core processor, a multi-core processor, a computing cluster, or any number of other configurations. The processor 106 may be implemented as Complex Instruction Set Computer (CISC) or Reduced Instruction Set Computer (RISC) processors, x86 Instruction set compatible processors, multi-core, or any other microprocessor or central processing unit (CPU). As an example, the main processor 106 includes dual-core processor(s), dual-core mobile processor(s), or the like.

The computing device 100 may include a memory device 108. The memory device 108 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The storage device 110 may be a non-transitory computer-readable storage medium. The storage device 110 may have instructions stored thereon that, when executed by a processing resource, such as the processor 106, cause the computing device 100 to perform operations. As an example, the operations may be executed by controllers 102, 104. The controllers 102, 104 can be implemented in hardware, implemented as machine-readable instructions executable on the processor(s) 106, or implemented as a combination of hardware and machine-readable instructions. In examples where the controllers 102, 104 are implemented at least in part with machine-readable instructions, these machine-readable instructions can be in the form of software executable on the processor(s) 106, or software or firmware executable by processors in the controllers 102, 104.

FIG. 2 illustrates the computing device 100 and a digital pen 200 associated with the computing device 100, for interacting with the touchscreen 206 of the device 100, according to an example. The computing device 100 may include capacitive touch control buttons 208 as device inputs for initiating device actions (e.g., returning to the home screen). As illustrated, the touchscreen 206 and the buttons 208 may be disposed on the display surface of the device 100. As described above, as the display surface of the device 100 has multiple forms of input (e.g., the touchscreen 206 and the buttons 208), it may not be desirable for the operations of one form of input to interfere with the operations of the other form of input.

Referring to FIG. 2, the digital pen 200 may interact with the touchscreen 206 without physically touching the touchscreen 206. For example, once the digital pen 206 is within a predefined distance 204 from the touchscreen 206 (e.g., 1 inch), the digital pen 206 may be able to interact with the computing device 100 via the touchscreen 206. The technology for determining whether the digital pen 206 is within the predefined distance 204 may vary. As an example, the digital pen 206 may include an active or passive circuit for generating a signal that is detected by the computing device 100, as will be further described. As an example, the digital pen 206 may include no circuit at all, but may be detected by the computing device 100 when the pen 206 is within the predefined distance 204.

As an example of being able to communicate with the device 100 without physically touching the touchscreen 206, the digital pen 200 may produce a signal (e.g., magnetic, electrical, capacitive) that is detected by a sensor board surface disposed within the device 100 once the pen 200 is within distance 204. Once the signal generated by the pen 200 is detected by the device 100, the device 100 (e.g., via the sensor board surface) may use the detected signal to determine the position and angle of the pen 200 with respect to the touchscreen 206.

As an example, the digital pen 200 may include an internal power source to generate the signal, or may not include an internal power source. For a digital pen that does not include an internal power source, the pen may be powered once it is within the predefined distance 204 from the device 100, for example, via electro-magnetic resonance (EMR). A weak EM field may be generated by the device 100, which induces a current in the digital pen 200 once the pen 200 is within the predefined distance 204. The current induced in the pen 200 may then power a resonance circuit for generating a magnetic field, such as described above. As described, detection of the digital pen 200 may be possible even in the case of operations in which the pen 200 remains hanging in the air at a short distance 204 from the touchscreen 206. Such pen events may be known as pen in-range or pen hover. A pen event where the digital pen 200 is physically touching the touchscreen (not illustrated) may be known as pen inking.

As an example, as soon as the touchscreen controller 102 detects a pen events (e.g., pen in range, pen hover, or pen inking), the touchscreen controller 102 may instruct the capacitive touch controller 104 (e.g., via 103) to ignore any button triggers via capacitive touch control buttons 208 for the entire duration of the pen event. Such instructions may be communicated via 103 from a GPIO of the touchscreen controller 102 to a GPIO of the capacitive touch controller 104.

As an example, rather than instructing the capacitive touch controller 104 to ignore any button triggers, the touchscreen controller 102 may disable the capacitive touch controller 104 via an enable/disable signal. For example, a GPIO from the touchscreen controller 102 may be connected to an enable signal on the capacitive touch controller 104. As illustrated, the capacitive touch controller 104 may then disable the capacitive touch control buttons 208 via 202. Upon completion of the detected pen event (e.g., the digital pen 200 is no longer within the predefined distance 204 of the device 100), the touchscreen controller 102 may either instruct the capacitive touch controller 104 to no longer ignore button triggers, or enable the capacitive touch controller 104 once again.

It may be advantageous to disable the capacitive touch controller 104 rather than instructing the capacitive touch controller 104 to ignore button triggers. For example, when disabling the capacitive touch controller 104 upon detecting a pen event, there may be no computation overhead during normal operation. However, if the capacitive touch controller 104 rather receives instructions to ignore button triggers, there may be minimal computation overhead, where the capacitive touch controller 104 may need to monitor its GPIO for such instructions at the same frequency that it monitors for button triggers from the capacitive touch control buttons 208.

As an example, the operations described above may be executed by logic at least partially comprising hardware logic. Hardware logic at least partially includes hardware, and may also include software, or firmware. Hardware logic may include electronic hardware including interconnected electronic components to perform analog or logic operations on the computing device 100. Electronic hardware may include individual chips/circuits and distributed information processing systems. The operations may include enabling and disabling the forms of input disposed on the display surface of the computing device 100 (e.g., the touchscreen 206 and the capacitive touch control buttons 208).

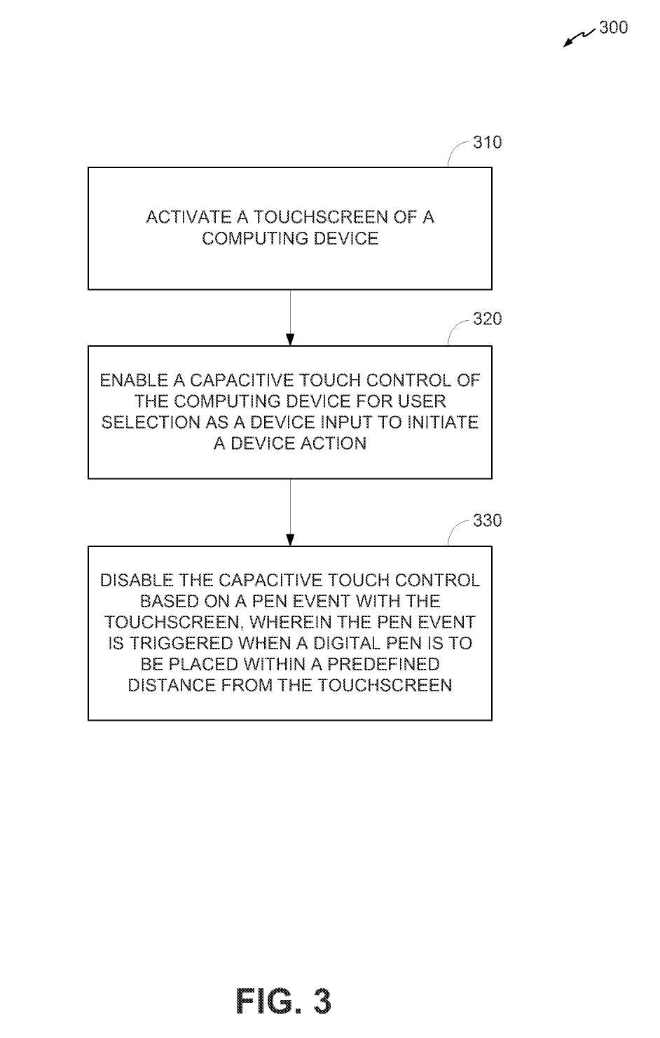

Referring to FIG. 3, a flow diagram is illustrated in accordance with various examples. The flow diagram illustrates, in a particular order, processes for controlling forms of input disposed on a display surface of a device (e.g., computing device 100). The order of the processes is not meant to limit the disclosure. Rather, it is expressly intended that one or more of the processes may occur in other orders or simultaneously. The disclosure is not to be limited to a particular example.

A method 300 may begin and progress to 310, where the device may activate a touchscreen of the device. As an example, the touchscreen may be controlled by a first controller (e.g., touchscreen controller 102). Progressing to 320, the device may enable a capacitive touch control of the device for user selection as a device input to initiate a device action. As an example, the capacitive touch control may be controlled by a second controller (e.g., capacitive touch controller 104).

Progressing to 330, the device may disable the capacitive touch control based on a pen event with the touchscreen. As an example, the pen event may be triggered when the digital pen is to be placed with a predefined distance from the touchscreen (e.g., distance 204). The digital pen may be in range to communicate with the device when the digital pen is to be placed within the predefined distance. As an example, the first controller may communicate with the second controller to disable the capacitive touch control when the digital pen is to be place within the predefined distance from the touchscreen.

Rather than disabling the capacitive touch control, the second controller may monitor for communications from the first controller, indicating when the digital pen is within the predefined distance from the touchscreen, Upon receiving such communications, the second controller may ignore device input from the capacitive touch control. When the digital pen is to be placed outside the predefined distance from the touchscreen, the capacitive touch control may be re-enabled, or the second controller may resume acknowledging device input from the capacitive touch control.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method comprising:
activating a touchscreen of a computing device;
enabling a capacitive touch control of the computing device for user selection as a device input to initiate a device action; and
disabling the capacitive touch control based on a pen event with the touchscreen, wherein the pen event is triggered when a digital pen is to be placed within a predefined distance from the touchscreen.

2. The method of claim 1, wherein the digital pen is in range to communicate with the computing device when the digital pen is to be placed within the predefined distance.

3. The method of claim 1, wherein the touchscreen is controlled by a first controller and the capacitive touch control is controlled by a second controller.

4. The method of claim 3, wherein the first controller is to communicate with the second controller to disable the capacitive touch control when the digital pen is to be placed within the predefined distance from the touchscreen.

5. The method of claim 3, comprising:
monitoring, at the second controller, for communications from the first controller, wherein the communications are to indicate when the digital pen is within the predefined distance from the touchscreen; and
ignoring device input from the capacitive touch control upon receiving the communications indicating the digital pen is within the predefined distance.

6. The method of claim 1, comprising:
re-enabling the capacitive touch control when the digital pen is be placed outside the predefined distance from the touchscreen.

7. The method of claim 1, wherein the predefined distance is based on a distance from the touchscreen of the computing device where the computing device is to begin detecting a magnetic field generated from the digital pen.

8. A computing device comprising:
a touchscreen;
a first controller to activate the touchscreen;
a capacitive touch control for user selection as a device input to initiate a device action; and
a second controller electrically connected to the first controller, wherein the second controller is to:
enable the capacitive touch control for the user selection; and
ignore the device input from the capacitive touch control based on a pen event with the touchscreen, wherein the pen event is triggered when a digital pen is to be placed within a predefined distance from the touchscreen.

9. The computing device of claim 8, wherein the second controller is to:
monitor for communications from the first controller, wherein the communications are to indicate when the digital pen is within the predefined distance from the touchscreen; and
ignore the device input upon receiving the communications indicating the digital pen is within the predefined distance.

10. The computing device of claim 8, wherein the second controller is to disable the capacitive touch control upon receiving communications from the first controller when the digital pen is to be placed within the predefined distance from the touchscreen.

11. The computing device of claim 10, wherein the second controller is to re-enable the capacitive touch control upon receiving communications from the first controller when the digital pen is to be placed outside the predefined distance from the touchscreen.

12. The computing device of claim 8, wherein the digital pen is in range to communicate with the computing device when the digital pen is to be placed within the predefined distance.

13. A computing device, comprising a non-transitory computer-readable storage medium and a plurality of programming instructions stored in the storage medium, in response to execution of the programming instructions by a processing resource, to cause the computing device to:
activate a first form of input of the computing device;
enable a second form of input of the computing device for user selection as a device input to initiate a device action; and
disable the second form of input based on a pen event with the first form of input, wherein the pen event is triggered when a digital pen is to be placed within a predefined distance from the first form of input.

14. The computing device of claim 13, wherein the storage medium comprises further programming instructions to cause the computing device to:
monitor for when the digital pen is within the predefined distance from the first form of input; and
ignore device input from the second form of input upon detecting when the digital pen is within the predefined distance.

15. The computing device of claim 13, wherein the storage medium comprises further programming instructions to cause the computing device to:
re-enable the second form of input when the digital pen is to be placed outside the predefined distance from the first form of input.
